(19) United States
(12) Patent Application Publication
(10) Pub. No.: US 2015/0308325 A1
(43) Pub. Date: Oct. 29, 2015

(54) DEVICE FOR CONTROLLING THE OPERATION OF A VENTILATOR, WHICH CAN BE DRIVEN BY A HYDRAULIC MOTOR, OF A COOLING DEVICE

(71) Applicant: HYDAC FLUIDTECHNIK GMBH, Sulzbach/Saar (DE)

(72) Inventors: Harald BAER, Puettlingen (DE); Josef Christian SCHAEFER, Saarlouis (DE)

(21) Appl. No.: 14/649,599

(22) PCT Filed: Nov. 9, 2013
(86) PCT No.: PCT/EP2013/003389

§ 371 Date: Jun. 4, 2015

(30) Foreign Application Priority Data
Dec. 5, 2012 (DE) 10 2012 024 207.7

(51) Int. Cl. F01P 5/04; F01P 7/04; F16H 61/4061

(52) U.S. Cl. CPC F01P 5/043; F16H 61/4061; F01P 7/044

(57) ABSTRACT

Disclosed is a device for controlling the operation of a ventilator, which can be driven by a hydraulic motor (1), of a cooling device, in particular in a working appliance for agricultural use, wherein the hydraulic motor (1) can be supplied with pressure fluid by means of a hydraulic pump (3) via a valve arrangement (7) than can be set to a first valve position for operation of the hydraulic motor (1) in a first direction of rotation and to a second valve position for operation of the hydraulic motor (1) in a second direction of rotation, a control device (21) being present, by means of which the valve arrangement (7) can be set to an intermediate position which reduces the pressure supply to the hydraulic motor (1) during transitions between the first and second valve positions for a time period that allows the ventilator speed to be reduced.

The invention relates to a device for controlling the operation of a ventilator, which can be driven by a hydraulic motor, of a cooling device, especially in working machinery for agricultural use, wherein the hydraulic motor can be supplied through a valve arrangement with hydraulic fluid by means of a hydraulic pump.

In cooling devices in which a flow of cooling air is generated by means of a motor driven ventilator and flows through the honeycomb or lamellar structure of the heat exchanger, the cooling output depends on the efficiency of the flow of the cooling air through the heat exchanger. A clogging of the air channels from impurities such as dust particles, which are entrained by the flow of cooling air, therefore impairs the cooling output and endangers the reliable operation of the systems to be cooled, such as hydraulic systems or radiators of internal combustion engines. In particular, ventilators of cooling devices which work in environmental conditions with a great deal of dust and which generate a strong flow of air by a ventilator working at high speed for a high cooling output, can become greatly soiled, and the heat exchanger can clog. This problem occurs particularly in equipment for industrial use such as combines, etc. where operation is associated with a great deal of dust. To provide a remedy, the option exists of reversing the direction of rotation of the ventilator in order to blow the collected contaminants out of the heat exchanger by reversing the direction of flow of cooling air. To prevent mechanical damage when switching the direction of rotation at the relevant high operating speeds of the ventilator and associated drive motor, and under the related high inertial force, the change in direction of rotation must occur without a sudden switchover, that is, in the form of “soft” switching, to keep the ventilator and ventilator motor from becoming damaged. This can be realized by supplying the hydraulic motor with hydraulic fluid by means of a proportional valve technology. Such solutions are comparatively lavish in terms of control and the cost of proportional valves.

In view of these problems, the object of the invention is to provide a device for controlling the operation of a hydraulically drivable ventilator which, without using a proportional technology, enables reliable and low-wear reversal of the rotational direction of the ventilator.

According to the invention, this object is achieved by a device having the features of claim 1 in its entirety.

A particular feature of the invention is that, in addition to two valve positions in which the hydraulic motor is in a first direction of rotation or in the opposite, second direction of rotation, the valve arrangement supplying the hydraulic motor can be adjusted to an intermediate position in which the pressure supply to the hydraulic motor is at least reduced, and a control device is available by means of which the valve arrangement can be adjusted to this intermediate position for a period which enables the ventilator speed to decrease. While the valve arrangement is adjusted to the intermediate position for a corresponding period by the control device, the speed can thereby be reduced, such as to zero, between the switch in rotational direction so that a reliable start in the opposite direction can occur.

In advantageous exemplary embodiments, the valve arrangement has a valve housing with at least one control spool which can move longitudinally therein to control connection positions in the valve housing in the form of at least two working connections, one pressure or supply connection or pump connection, as well as one tank connection. Such a valve can be designed in the form of a 4/3 directional spool valve.

The arrangement can advantageously be such that the control spool can be subject to control forces on its opposing sides, wherein fluid pressure originating hum the control device impinges on one side, and spring pressure from a spring arrangement with at least one compression spring acts on the opposing side. The hydraulic control provided in this manner simplifies the complexity of the control.

In this regard, the control device can have a directional spool valve, preferably a 3/2 directional valve that is connected at the input side to the preferably adjustable hydraulic pump, and at the output side to the assigned side of the control spool of the valve arrangement.

In a particularly advantageous manner, the arrangement can be such that the spring pressure ran be exerted on the control spool by two compression springs preferably arranged concentric to each other which preferably possess spring stiffnesses which differ from each other, and are adapted to pressure level stages of the time originating from the control device such that at one pressure level stage, the valve arrangement passes from the first valve position to the second intermediate position, and at the other pressure level stage, from the intermediate position to the second valve position. With a slight amount of control effort, the valve arrangement can be adjusted to all positions by using a single control line connected to the control device valve such that an advantageously slight amount of control effort is necessary.

In regard to the design of the compression spring device, the arrangement can be advantageously such that the control spool forms step surfaces which are offset from each other at the end facing the pressures springs, and a first compression spring contacts the outermost step surface such that the control spool can be moved into the intermediate position against the force of the first compression spring upon moving out of the first valve position, and the control spool, upon moving out of the intermediate position into the second valve position,

interacts with the inner second compression spring by means of the inner second step surface such that the control spool can move against the force of both compression springs into the second valve position when the control device supplies the control pressure of the second pressure level stage.

In exemplary embodiments in which the second compression spring coaxially surrounds the first compression spring, the arrangement is advantageously such that the second, or compression spring is braced against a slide ring which is on the end facing the control spool and is fixed in a retaining position against axial movement in the direction towards the control spool, and which the inner, second step surface of the control spool abuts in the intermediate position, and the slide ring moves axially against the force of the second compression spring during the movement into the second valve position.

In one advantageous design of the valve arrangement, the control spool has three steps in the form of radial elevations which run along the valve housing and which form control edges that interact in a controlling manner with the housing connections, wherein a first fluid chamber is formed between a first step on the end subject to fluid pressure by the control device and the middle step, and a second fluid chamber is formed between the middle step and the third step at the end facing the compression springs. The connecting points can be assigned to the fluid chambers such that, in the first valve position, the fluid connection between a working connection and a tank connection is formed via the first fluid chamber, and the fluid connection between the pressure connection and the other working connection is formed via the second fluid chamber.

In particularly advantageous exemplary embodiments, the control edges of the middle step are provided with a bevel, and the middle step is aligned with the pressure connection when the control spool is in the intermediate position, such that a throttled fluid connection between the pressure connection and the working connections via the first and second fluid chamber is formed by the bevels, wherein the fluid connection between one working connection and one tank connection via the first fluid chamber is released in the intermediate position, and the fluid connection between the other working connection and another tank connection is released via the second fluid chamber. Thanks to the throttled connection at the tank side, a volumetric flow remains in the intermediate position such that the variable pump, turned down to the pressure level corresponding to the intermediate position, can maintain this pressure level.

In the second valve position, the fluid connection via the first fluid chamber between the pressure connection and a working connection is released, and the fluid connection via the second fluid chamber between the other working connection and the tank connection is released.

In advantageous exemplary embodiments, a leakage line is provided, wherein leakage connections are provided on the valve housing of the valve arrangement, and an inlet side connection is available at the valve of the control device and connects to the leakage line.

With such a device design, the variable pump can be adjusted to a correspondingly low pressure level corresponding to the intermediate position of the valve arrangement starting from the operating pressure provided to operate the hydraulic motor in order to introduce transitions between the first and second valve position, the lower pressure causing the 3/2 directional valve of the control device of the valve arrangement to adjust the control spool to the intermediate position to decrease the speed of the hydraulic motor, wherein after a sufficient time for the decrease in speed, the variable pump can be turned up to the operating pressure level, and a directional valve for the control device can be locked for the transition from intermediate position to the first or second valve position, or can be moved into the released state to supply the operating pressure level to the valve arrangement.

In the following, the invention will be explained in detail with reference to an exemplary embodiment depicted in the drawing. In the figures:

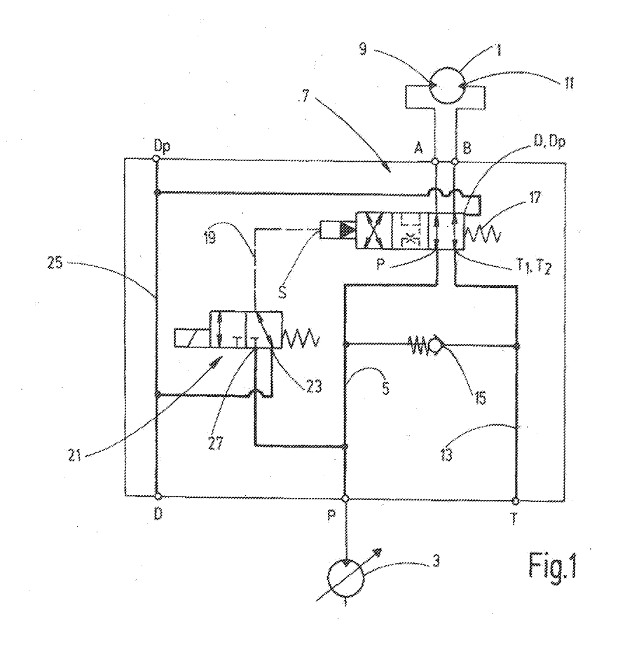

FIG. 1 shows a symbolic depiction of the hydraulics diagram of an exemplary embodiment of the device according to the invention;

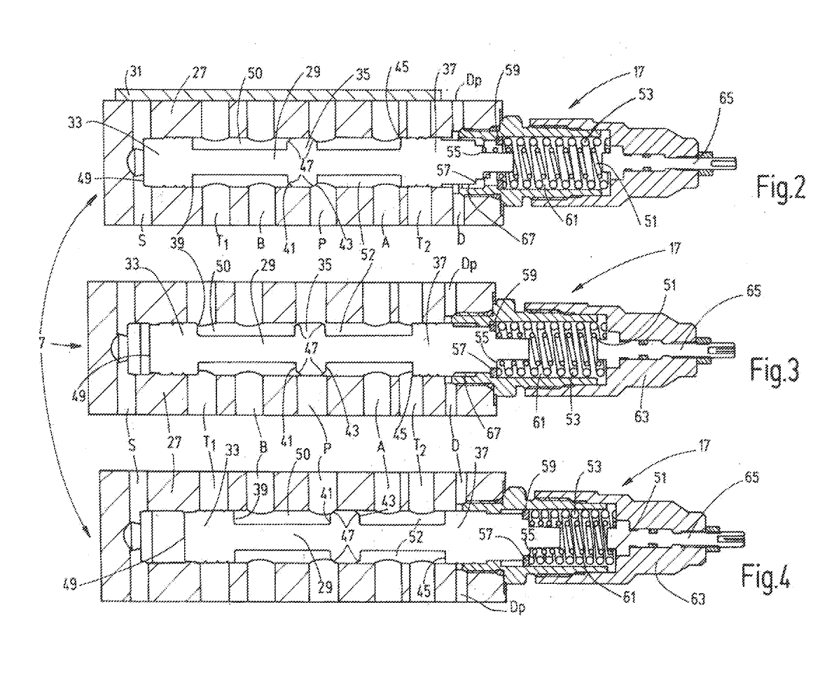

FIG. 2 shows a longitudinal section of the valve arrangement of the exemplary embodiment, wherein a first valve position is shown; and

FIGS. 3 and 4 show longitudinal sections corresponding to FIG. 2, wherein an intermediate position and a second valve position of the valve arrangement are shown.

Of a cooling device for working machinery such as a combine, FIG. 1 only a shows a hydraulic motor 1 serving to drive a ventilator (not shown) which can be actuated in both rotational directions. The hydraulic motor 1 can be provided with hydraulic fluid by means of a variable pump 3 to drive the ventilator in one rotational direction or the other rotational direction, the hydraulic fluid having an operating pressure level and passing via a pressure line 5 to the pressure or pump connection P of a valve arrangement 7. The valve arrangement has a 4/3 directional spool valve with working connections A and B which are connected to one connecting side 9 or the second connecting side 11 of the hydraulic motor 1. Depending on the valve position of the valve arrangement 7, the pressure connection P is connected to working connection A for clockwise rotation of the hydraulic motor 1, or to working connection B for counterclockwise rotation of the hydraulic motor, wherein the other working connection is connected in each case to a tank connection T₁, T₂ of the valve arrangement 7. With the valve position of the valve arrangement 7 shown in FIG. 1, the pressure connection P is connected to the working connection A, and hence to the connecting point 9 of the hydraulic motor 1, for clockwise rotation of the hydraulic motor 1, whereas the working connection B is connected to the tank connection T ₁, T₂ which is connected a tank line 13 running to the tank (not shown). A check valve 15 that blocks the tank line 13 is arranged between the pressure line 5 and tank line 13.

The first valve arrangement 7 is pretensioned by a spring arrangement 17 in the valve position shown in FIG. 1 corresponding to the clockwise rotation of the hydraulic motor 1. For transitions out of this valve position, the valve arrangement 7 can be hydraulically actuated by supplying a control pressure to a control connection S of the valve arrangement 7 via a control line 19 which is connected to a control device 21. In the present example, this has a 3/2 proportional valve which is electrically actuatable for applying a fluid pressure level to the control connection S of the valve arrangement 7 via the control line 19, or to at least substantially render the control connection S pressure free. The operating state in FIG. 1 is shown where the 3/2 proportional valve of the control device 21 connects the control line 19 to an input side connection 23 which leads to a leakage line 25.

The other input-side connection 27 of the 3/2 proportional valve of the control device 21 is connected to the pressure line 5 and hence to the pressure side of the variable pump 3. To electrically actuate the control device 21 which is mechanically pretensioned lit the displayed position, there is an electronic control device which can be as for desired switchovers o the rotational direction of a hydraulic motor 1 to actuate the 3/2 proportional valve of the control device in a manner described further below, and to adjust the variable pump 3 to an operating pressure level, or to a lower pressure level for switchovers of the rotational direction.

FIGS. 2 to 4 show further details of the valve arrangement 7 having a special 4/3 directional spool valve. FIG. 2 corresponds to the valve position for clockwise rotation of the hydraulic motor 1 shown in FIG. 1. The 4/3 proportional spool valve of the valve arrangement 7 has a cylindrical valve housing 27 with a control spool 29 which can be moved longitudinally to control connecting points on the valve housing 27. These connecting points (from left to right in the drawing) are a first tank connection T₁, a working connection B, a pressure or pump connection P, a working connection A and a second tank connection T₂.

These connecting points are formed by through holes in the valve housing 27 which are sealed tight by a cover 31 on a housing side so that the connections are only open on a connection side. In the depiction in FIG. 2, the cover 31 is provided on the top side. In the depiction in FIGS. 3 and 4, the cover 31 is left out. The control spool 29 for controlling the connections has three steps which are axially offset relative to each other, that is, a first step 33 provided on the left end of the control spool 29, a middle step 35, and a third step 37 on the end facing the spring arrangement 17. The steps are formed by radial elevations which run along the inside of the valve housing 27 and form control edges in the matter conventional to spool valves, the control edges interacting a controlling manner with the connections. During the shifting movements of the control spool 29, the control edge 39 of the first step 33 interacts in a controlling manner with the first tank connection T. The middle step 35 has a left-side control edge 41 and right-side control edge 43 which interact in a controlling manner with the pressure connection P. The control edge 45 on the third step 37 step interacts in a controlling manner with the second tank connection T₂. The control edges 41 and 43 of the middle step 35 are each provided with a bevel 47. These for the throttle positions when the spool position is aligned with the pressure connection P to throttle the passage of fluid during the blocking position. A first fluid chamber 50 is formed between the first step 33 and the middle step 35, and a second fluid chamber 52 is formed between the middle step 35 and right-side intermediate step 37.

To actuate the valve arrangement 7, fluid pressure can he applied via the control connection 7 to the end 49 of the control spool 29 on the left side. This allows the control spool 29 to move against the spring force of the spring arrangement 17 acting at the other end. FIG. 2 shows the valve position in which the control spool 29 is moved by spring pressure into the left-side end position when there is fluid pressure on the control connection S. This corresponds to the first valve position for clockwise rotation of the hydraulic motor 1, Wherein the pressure connection P is formed via the second fluid chamber 52 to the working connection 8, whereas the fluid connection between the working connection B and tank connection T via the first fluid chamber 50 is released. In this operating state, the hydraulic motor 1 is operated by the variable pump 3 supplying the operating fluid at the operating pressure level. The 3/2 proportional valve is in the mechanically pretensioned blocking position which is shown in FIG. 1, during which the control line 19 is connected via the input-side connection 23 to the pressure-free leakage line 25.

FIG. 3 shows the intermediate position, of the valve arrangement in which the control spool 29 is in a middle position, wherein the middle step 35 is aligned with the pressure connection P to create a throttled fluid connection by means of the bevels 47 between the pressure connection P and the working connections B and A via the first fluid chamber of 50 or second fluid chamber 52. At the same time in this intermediate position, the fluid connection between the working connection B and tank connection T₁ via the first fluid chamber 50 is released, and the fluid connection between the working connection A and tank connection T₂ via the second fluid chamber 52 is released. In this valve position, the pressure supply of the hydraulic motor 1 is interrupted since both working connections A and B are connected to the tank line 13. This means that the ventilator precedingly rotating at the operating speed continues to run, due to the rotating mass, possibly to a standstill.

In order to transfer the valve arrangement into this intermediate position, the control spool 29 is supplied with hydraulic fluid in a first pressure stage from the control connection S and is shifted against the effect of the spring arrangement 17. In order to transfer the valve arrangement into this intermediate position, the control spool 29 is supplied with hydraulic fluid in a first pressure stage from the control connection S and is displaced against the effect of the spring arrangement 17. This spring arrangement has two concentrically arranged pressure springs, of which a first, interior pressure spring 51 directly abuts the assigned end of the control spool 29. The spring arrangement 17 is designed such that the second, exterior pressure spring 53 engages with the control spool 29 with its additional spring force only after it has moved into the intermediate position in FIG. 3. To this end the control spool 29 has step surfaces winch am axially offset from each other on the relevant end, that is, an outer step surface 55 which the first spring 51 engages, as well as an inner step surface 57. Accordingly, during the movement from the first valve position (FIG. 2) into the intermediate position (FIG. 3), only the opposing spring force of the first pressure spring 51 must be overcome. When the intermediate position is reached, the inner step surface 57 comes to rest on a slide ring 59 against which, in turn, the second pressure spring 53 abuts, and the stop position shown in FIG. 2 and 3 is restrained from moving to the left; however, it can move to the right when the second pressure spring 53 is compressed. This means that after the intermediate position is reached, the control spool 29 continues to move into the second valve position, which is shown in FIG. 4, against the combined spring pressure from the first pressure spring 51 and the second pressure spring 53. FIG. 4 shows the state in which the slide ring 59 is shifted to the right out of the stop position, and both, pressure springs 51 and 53 are compressed.

As shown in FIGS. 2 to 4, the spring arrangement 17 has a spring housing which is screwed in a sealing manner into the end of the valve housing 27, and has a spring chamber 61 with a hat-like sealing body 63 with a setting screw 65 located therein which enables the setting of the spring rate. Instead of two springs 51, 53, individual springs with a progressive characteristic (not shown) can be used.

This stepped spring effect of the spring arrangement 17 makes it possible to move the control spool 29 from the first valve position into the intermediate position by supplying the control connection S with a first level of pressure, and to transfer it into the second valve position against the combined spring pressure of both pressure springs 51, 53 by means of a higher pressure level. In this valve position (see FIG. 4), pressure connection P is connected to working connection B for counterclockwise rotation of the hydraulic motor 1, whereas working connection A is connected to the second tank connection T₂ In all valve positions, the leakage connections D and Dp are connected to the leakage line 25 (FIG. 1) and provide ventilation to the spring chamber 61 through a groove 67. In the depicted design, a “soft” switchover of the rotational direction is enabled as the variable pump 3 is turned down from the normal operating pressure level at which the ventilator is driven at operating speed by the hydraulic motor 1, to a lower pressure level, the switchover level of for example, 10 bar, and this switchover pressure level is enabled by the control device 21 at the control connection S of the valve arrangement 7 such that the valve arrangement 7 passes from the first valve position or second valve position into the intermediate position, and the speed of the hydraulic motor 1 decreases. When the after-running of the ventilator has ceased sufficiently, the variable pump 3 is again turned up to the operating pressure level, and the operating pressure level is applied by the control device 21 to the control connection S in order to move the control spool 29 against the force of both springs 51, 53 into the second valve position by means of the correspondingly high pressure level. If the switchover from clockwise rotation to counterclockwise rotation is to occur, the pressure supply to the control connection S is suppressed by switching the 3/2 proportional valve of the control device 21 to the blocking state such that in this case, the transition occurs from the intermediate position (FIG. 3) to the second switching position (FIG. 4).

1. A device for controlling the operation of a ventilator, which can be driven by a hydraulic motor (1), of a cooling device, in particular in working machinery for agricultural use, wherein the hydraulic motor (1) can be supplied with pressure fluid by means of a hydraulic pump (3) via a valve arrangement (7) than can be set to a first valve position for operation of the hydraulic motor (I) in a first direction of rotation and to a second valve position for operation of the hydraulic motor (I) in a second direction of rotation, a control device (21) being present by means of which the valve arrangement (7) can be set to an intermediate position which reduces the pressure supply to the hydraulic motor (1) during transitions between the first and second valve positions for a time period that allows for a reduction of the ventilator speed.

2. The device according to claim 1, characterized in that the valve arrangement (7) has a valve housing (27) with at least one control spool (29) which can move longitudinally therein to control connection positions (27) in the valve housing in the form of at least
two working connections (A, B),
one pressure or supply connection or pump connection, as well as
one tank connection (Ti, T2).

3. The device according to claim 1, characterized in that the control spool (29) is acted upon by control forces on its opposing sides, wherein fluid pressure originating from the control device (21) impinges on one side (49), and spring pressure from a spring arrangement (17) having at least one compression spring (51, 53) impinges on the opposing side.

4. The device according to claim 1, characterized in that the control device (21) has a directional spool valve, preferably a 3/2 directional valve, that is connected at the input side to the preferably adjustable hydraulic pump (3), and at the output side to the associated side (49) of the control spool (29) of the valve arrangement (7).

5. The device according to claim 1, characterized in that the spring pressure can be exerted on the control spool (29) by two compression springs (51, 53) preferably arranged concentric to each other which preferably possess spring stiffnesses that differ from each other, and are adapted to pressure level stages of the fluid pressures originating from the control device (21) such that, at one pressure level stage, the valve arrangement (7) passes from the first valve position to the second intermediate position, and at the additional pressure level stage, from the intermediate position to the second valve position.

6. The device according to claim 1, characterized in that the control spool (29) forms step surfaces (55, 57) which are offset from each other at the end facing the pressures springs (51, 53), and a first compression spring (51) acts on the outermost step surface (55) such that the control spool (29) can be moved into the intermediate position against the force of the first compression spring (51) upon moving out of the first valve position, and the control spool (29), upon moving out of the intermediate position into the second valve position, also interacts with the inner second compression spring (52) by means of the inner second step surface (57) such that the control spool can move against the force of both compression springs (51, 53) into the second valve position.

7. The device according to claim 1, characterized in that the second compression spring (53) coaxially surrounds the first compression spring (51) and is braced against a slide ring (59) which is on the end facing the control spool (29) and is fixed in a retaining position against axial movement in the direction towards the control spool (29), and which is abutted by the inner, second step surface (57) of the control spool (29) in the intermediate position, and the slide ring (59) moves axially against the force of the second compression spring (53) during the movement into the second valve position.

8. The device according to claim 1, characterized in that the control spool (29) has three steps (33, 35, 37) in the form of radial elevations which run along on the valve housing (27) and which form control edges (39, 41, 43, 45) that interact in a controlling manner with the housing connections, and a first fluid chamber (50) is formed between a first step (33) on the end (49) subject to fluid pressure by the control device (21) and the middle step (35), and a second fluid chamber (52) is formed between the middle step (35) and the third step (37) at the end facing the compression springs (51, 53).

9. The device according to claim 1, characterized in that, in the first valve position, the fluid connection between the working connection (B) and tank connection (T1) is formed via the first fluid chamber (50), and the fluid connection between the pressure connection (P) and the working connection (A) is formed via the second fluid chamber (52).

10. The device according to claim 1, characterized in that the control edges (41, 43) of the middle step (35) are provided with a bevel (47), and the middle step (35) is aligned with the pressure connection (P) when the control spool (29) is in the intermediate position such that a throttled fluid connection between the pressure connection (P) and the working connections (B and A) via the first (50) and second fluid chamber (52) is formed by the bevels (47), and the fluid connection between working connection (B) and tank connection (T1) via the first fluid chamber (50) is released in the intermediate position, and the fluid connection between the working connection (A) and tank connection (T2) via the second fluid chamber (52) is released.

11. A device according to claim 1, characterized in that in the second valve position, the fluid connection between the pressure connection (P) and working connection (B) via the first fluid compartment (50), and between the working connection (A) and the tank connection (T2) via the second fluid compartment (52), are released.

12. The device according to claim 1, characterized in that a leakage line (25) is provided, and leakage connections (D and Dp) are provided on the valve housing (27) of the valve arrangement (7), and an inlet-side connection (23) is provided on the valve of the control device (21) which is connected to the leakage line (25).

13. The device according to claim 1, characterized in that the variable pump (3) can be adjusted to a low pressure level corresponding to the intermediate position of the valve arrangement (7) starting from the operating pressure provided to operate the hydraulic motor (I) in order to introduce transitions between the first and second valve position, the lower pressure causing the 3/2 directional valve of the control device (21) of the valve arrangement (7) to adjust the control spool (29) to the intermediate position, to decrease the speed of the hydraulic motor (1), wherein after a time sufficient for the decrease in speed, the variable pump (3) can be turned up to the operating pressure level, and a directional valve for the control device (21) can be locked for the transition from the intermediate position to the first or second valve position, or can be moved into the released state to supply the operating pressure level to the valve arrangement (7).
